(19) United States
(12) Patent Application Publication
(10) Pub. No.: US 2012/0263406 A1
(43) Pub. Date: Oct. 18, 2012

(54) ROLLING BEARING, NOTABLY FOR A CLUTCH RELEASE BEARING DEVICE

(75) Inventors: Benoit ARNAULT, SAINT CYR SUR LOIRE (FR); Jean-Philippe CLAUVELIN, WURZBURG (DE)

(73) Assignee: AKTIEBOLAGET SKF, Goteborg (SE)

(21) Appl. No.: 13/402,190

(22) Filed: Feb. 22, 2012

(30) Foreign Application Priority Data
Feb. 22, 2011 (FR) FR1151410

(51) Int. Cl. F16C 33/76

(52) U.S. Cl. 384/484

(57) ABSTRACT

The rolling bearing comprises an inner ring, an outer ring and at least one row of rolling elements mounted between the said rings, one of the rings comprising at least one seal and being able to move angularly relative to the other ring so as to allow an angular tilting of the axis of the said ring relative to the axis of the other ring. The seal comprises at least one sealing lip made of a flexible material.

The rolling bearing comprises at least one abutment means made of a rigid material and capable of interacting by contact with the rolling elements in order to limit the angular tilting of the moveable ring.

### CROSS-REFERENCE

This application claims priority to French Application No. FR1151410 filed on Feb. 22, 2011.

### FIELD OF THE INVENTION

The present invention relates to the field of rolling bearings notably used in clutch release bearing devices deigned to act on the diaphragm of a clutch, in particular for a motor vehicle.

### BACKGROUND OF THE INVENTION

Such devices comprise a rolling bearing of which one of the rings rotates and the other is fixed, the rotating ring being furnished with a radial leading surface designed to come into contact with the end of the fingers comprising the diaphragm of the clutch.

A non-rotating operating element supports the rolling bearing and, under the action of a control member (mechanical, electrical or hydraulic), axially moves the bearing to cause the leading surface of the rotating ring to press against the diaphragm of the clutch and actuate the clutch mechanism.

Through document FR-A1-2 944 843 (SKF), a rolling bearing is known for a clutch release bearing device comprising an inner ring, an outer ring, a row of balls mounted between the rings, and a seal fixed to the outer ring and provided with a lip rubbing against the inner ring. So as to be able to cater for the angular alignment defects of the axes of the bearing and of the clutch diaphragm, the outer ring can tilt angularly relative to the axis of the inner ring so as to be able to align itself on the axis of the diaphragm. The tilting of the outer ring may also occur during the handling or transport of the bearing.

During the tilting or swiveling of the outer ring, the friction lip of the seal can lodge itself between the balls and the raceway of the inner ring. This causes the friction lip to deteriorate and subsequently leads to a faulty sealing of the bearing.

### SUMMARY OF THE INVENTION

The object of the present invention is to remedy this drawback. More particularly, the object of the present invention is to provide a rolling bearing, notably for a clutch release bearing device that can cater for the angular alignment defects of the axis of the bearing and of that of an external system against which it is designed to be mounted, while ensuring an effective seal.

In one embodiment, the rolling bearing comprises an inner ring, an outer ring and at least one row of rolling elements mounted between the said rings, one of the rings comprising at least one seal and being able to move angularly relative to the other ring so as to allow an angular tilting of the axis of the said ring relative to the axis of the other ring. The seal comprises at least one sealing lip made of a flexible material. The rolling bearing comprises at least one abutment means made of a rigid material and capable of interacting by contact with the rolling elements in order to limit the angular tilting of the moveable ring.

Advantageously, the abutment means is offset axially towards the rolling elements relative to the sealing lip.

Preferably, the abutment means is made of a metal material.

In one embodiment, the angle formed in cross section between a radial mid-plane passing through the centre of the rolling elements and a plane passing through the said centre and the contact zone between the abutment means and the rolling elements is within the angular range from 5° to 50°.

In one embodiment, the seal comprises an end-piece provided with at least one rib protruding towards the rolling elements and forming the abutment means.

Alternatively, the angularly moveable ring may comprise a bearing portion on which the seal is mounted and forming the abutment means. Preferably, the seal comprises an end-piece mounted directly or indirectly against the bearing portion of the moveable ring.

In one embodiment, at least the angularly moveable ring is made in a single piece by stamping. The said ring may be the outer ring.

According to another aspect, the invention also relates to a clutch release bearing device comprising a rolling bearing as defined above and a means for axially securing the rolling bearing to an operating element.

### BRIEF DESCRIPTION OF THE DRAWINGS

The present invention will be better understood on studying the detailed description of embodiments taken as non-limiting examples and illustrated by the appended drawings in which:

FIGS. 1 and 2 are views in axial section of a clutch release bearing device according to a first exemplary embodiment in the free state and in the mounted state respectively,

FIG. 3 is a view in axial section of a bearing device according to a second exemplary embodiment in the free state, and

FIGS. 4 and 5 are views in axial section of a clutch release bearing device according to a third exemplary embodiment in the free state and in the mounted state respectively.

### DETAILED DESCRIPTION OF THE INVENTION

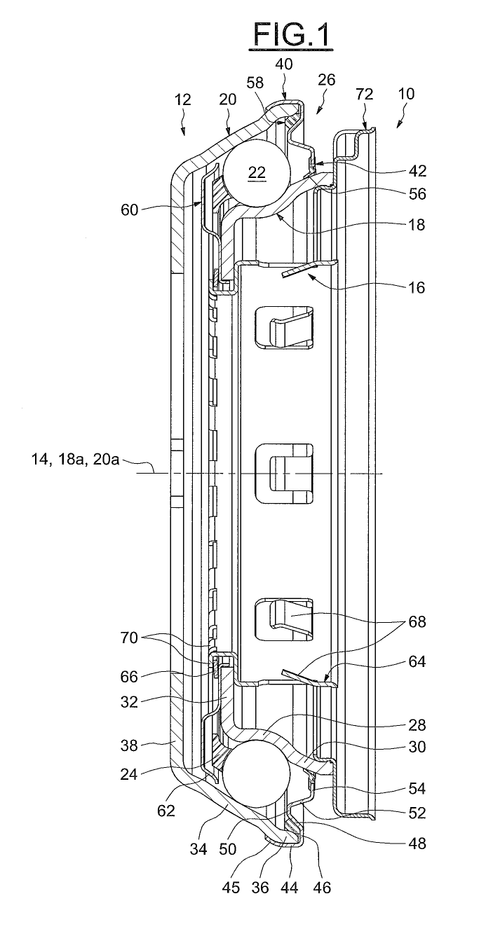

In FIG. 1, a clutch release bearing device, referenced 10 in its entirety, comprises a rolling bearing 12, with a rotation axis 14, and an axially securing means 16 provided between the rolling bearing 12 and an operating element (not shown) actuating the device.

The rolling bearing 12 comprises a non-rotating inner ring 18, a rotating outer ring 20, a row of rolling elements 22, here made in the form of balls and mounted between the said rings, a cage 24 for maintaining the even circumferential spacing of the rolling elements, and a seal 26 mounted on the outer ring.

The thin-walled inner ring 18, with its axis 18a, may advantageously be made by stamping a metal sheet or a steel tube. It comprises a toroidal portion 28 comprising a toroidal raceway for the rolling elements 22 having in cross section a concave internal profile in a quarter circle. The inner ring 18 also comprises an oblique portion 30 and a radial portion 32 directed inwards. The said oblique portion 30 and radial portion 32 are placed on either side of the rolling elements 22 and connected together by the toroidal portion 28. The oblique portion 30 extends the large-diameter edge of the toroidal portion 28.

The thin-walled outer ring 20, with its axis 20a, may also advantageously be made by stamping a metal sheet or a steel tube. It comprises an oblique portion 34 internally delimiting a portion of a sphere the centre of which coincides with the axis 14 of the rolling bearing and forming a raceway for the rolling elements 22. This raceway forms a deflection raceway on which the rolling elements 22 can move depending on the angular position of the outer ring 20 relative to the inner ring 18. For further details on such a raceway, it is possible for example to refer to document FR-A1-2 944 843. The outer ring 20 also comprises an axial portion 36 and a radial portion 38 directed inwards. The said axial portion 36 and radial portion 38 are placed on either side of the rolling elements 22 and are connected together by the oblique portion 34. The axial portion 36 extends the large-diameter edge of the oblique portion 34 and radially surrounds the oblique portion 30 of the inner ring 18. The retaining cage 24 is placed radially between the radial portion 32 of the inner ring and the oblique portion 34 of the outer ring.

The annular seal 26 comprises a reinforcement or end-piece 40 on which is placed an internal sealing packing 42 made of a flexible material and making a dynamic seal with the inner ring 18. As will be described in greater detail below, the end-piece 40 makes it possible to limit the angular tilting of the outer ring 20 relative to the inner ring 18.

The end-piece 40 is made of a rigid material, for example of metal. It may advantageously be made by stamping, die-cutting and folding of a metal sheet or of a steel tube. Alternatively, the end-piece 40 may be made of rigid synthetic material, for example of polyamide. The end-piece 40, of generally annular shape, is mounted on the outer ring 20 and extends towards the inner ring 18. It comprises an axial portion 44 in contact against the outer surface of the axial portion 36 of the outer ring and extended by an end edge 45 folded back onto the said outer ring 20, for example by crimping, in order to ensure the axial and circumferential retention of the seal 26. The axial portion 44 is extended, on the side opposite to the end edge 45, by a radial portion 46 extending inwards and of which the small-diameter edge is extended by an oblique portion 48 extending towards the rolling elements 22, itself extended by a radial portion 50. The radial portion 50 is extended by an oblique portion 52 extending radially inwards and axially on the side opposite to the rolling elements 22, which is itself extended by a radial portion 54 extending inwards towards the oblique portion 30 of the inner ring.

The sealing packing 42 is overmoulded or vulcanized onto the free end of the radial portion 54 of the end-piece 40. The packing 42 may be made of elastomer, for example such as nitrile rubber. The packing 42 comprises an annular heel (not referenced) covering the free end of the radial portion 54 of the end-piece and an annular sealing lip 56 extending inwards from the said heel. The sealing lip 56 extends obliquely inwards and downwards and comes into frictional contact with the outer surface of the oblique portion 30 of the inner ring. The free end of the lip 56 is axially set back from the radial portion 50 of the end-piece.

The seal 26 also comprises an external sealing packing 58 made of a flexible material and making a static seal with the outer ring 20. The packing 58 is overmoulded or vulcanized onto the radial portion 46 and oblique portion 48 of the end-piece and may be made of elastomer, for example such as nitrile rubber.

The rolling bearing 12 also comprises a sealing end-piece 60 attached to the inner ring 18 axially on the side opposite to the seal 26. The end-piece 60, of generally annular shape, is fixed in the bore of the radial portion 32 of the inner ring and mounted axially pressing against the said radial portion 32. The end-piece 60 extends radially between the radial portion 38 of the outer ring and the cage 24, and comprises a peripheral rim 62 radially surrounding the said cage. The rim 62 forms a seal by narrow passage with the oblique portion 34 of the outer ring.

The means 16 for axially securing the device is of the type allowing a certain radial movement of the inner ring 18 relative to the operating element. The means 16 for axially securing comprises a fixing ring 64 and an axially elastic washer 66 for example of the

Belleville washer type, distinct from one another. The fixing ring 64 presses axially against the radial portion 32 of the inner ring axially on the side opposite to the end-piece 60. The ring 64 comprises a first group of tabs 68 provided for ensuring its axial attachment to the operating element, and a second group of tabs 70 extending radially outwards and pressing axially against the inner edge of the washer 66. The outer edge of the washer 66 is in contact with the end-piece 60.

The device 10 also comprises a coupling element 72 that snap-fits onto the free end of the oblique portion 30 of the inner ring and is designed to provide the interface between a prestress spring (not shown) and the inner ring 18.

As illustrated in FIG. 1, in a neutral position of the rolling bearing 12, for example before mounting against the diaphragm of the clutch system, the axes 18a, 20a of the inner and outer rings are coaxial with one another and with the axis 14 of the bearing.

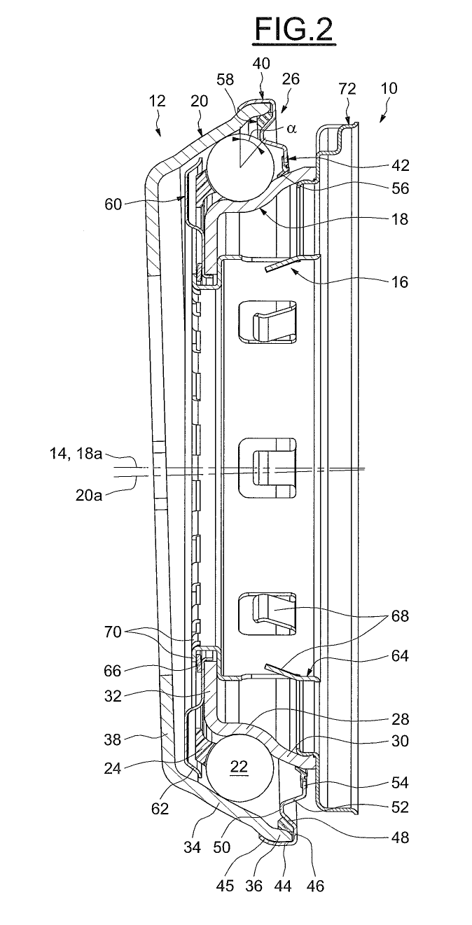

When the rolling bearing 12 is put in place against the diaphragm with an axial preload, the outer ring 20 makes it possible to cater for the annular alignment defects that exist between the axis 14 of the rolling bearing and the axis of the diaphragm. Specifically, when there is contact between the diaphragm and the radial portion 38 of the outer ring, the said ring can tilt angularly so that its axis 20a is aligned with the axis of the diaphragm while remaining in the same radial plane as that containing the axes 14 and 18a. In FIG. 2, the illustrated angular tilt of the axis 20a relative to the axes 14 and 18a is for example less than or equal to 2°.

The angular tilt of the outer ring 20 is limited by the end-piece 40 of the seal 26. More precisely, during this tilting, the zone of junction connecting the radial portion 50 and the oblique portion 52 of the end-piece comes into direct contact against the rolling elements 22 so as to limit the swiveling capability of the outer ring 20. In a neutral position of the rolling bearing 12, the zone of the end-piece designed to butt against the rolling elements 22 is offset axially towards the said rolling elements relative to the lip 56 of the seal. In this neutral position, the axial distance separating the rolling elements 22 from the zone of the end-piece 40 forming an abutment is determined according to the maximum angular tilt allowed for the outer ring 20. This axial distance is chosen so that, when there is contact between the end-piece 40 and the rolling elements 22, the lip 56 of the seal remains situated axially at a distance from the said rolling elements. Thus, during the tilting of the outer ring 20 in operation, or else during the transport and/or the handling of the rolling bearing 12, the sliding of the lip 56 is prevented between the rolling elements 22 and the raceway of the inner ring 18.

The oblique portions 48, 52 and the radial portion 50 of the end-piece form an annular rib protruding towards the rolling elements 22 and forming an abutment means designed to rest against the rolling elements during the angular deflection of the outer ring 20 relative to the inner ring 18. As a variant, it could be possible to form, on the end-piece 40, a plurality of ribs forming abutments extending towards the rolling elements 22 and spaced relative to one another in the circumferential direction.

The production in a rigid material, for example metal, of the abutment means is particularly advantageous relative to a solution made of flexible material. Specifically, with a flexible material, if the abutment means of the end-piece 40 comprise a moulding burr, the rotation of these elements may separate this burr from the seal and draw it into the bearing space when there is contact between the rolling elements 22. This causes contamination of the bearing. Moreover, such a tearing of material may cause a deformation of the abutment means which may cause a greater pivoting or swiveling of the outer ring than that determined during the design of the rolling bearing 12. Producing the abutment means of the end-piece 40 in rigid material avoids these drawbacks while ensuring over time a good seal for the rolling elements 22 while retaining in operation one and the same angular deflection that is admissible for the outer ring 20.

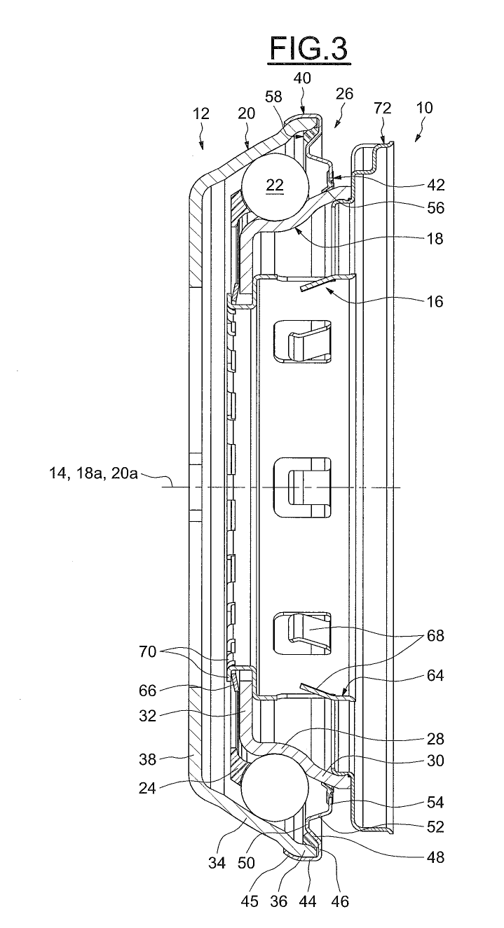

Advantageously, the angle a (FIG. 2) formed in cross section between the radial plane passing through the centre of the rolling elements 22 and the plane passing through the said centre and the contact zone between the end-piece 40 and the said rolling elements is within an angular range of 5° to 50°. With a contact in this angular range, the step provided at the end of the raceway of the inner ring 18 situated on the side of the radial portion 32 makes it possible to retain a unitary assembly, during the handling and the transport of the rolling bearing 12. Therefore, it is possible to remove the sealing end-piece 60 also serving to perform, before mounting, the axial retention of the various elements forming the rolling bearing 12, as is illustrated in the variant embodiment of FIG. 3 in which the identical elements bear the same references. In this variant, the elastic washer 74 comes directly to bear axially against the radial portion 32 of the inner ring 18.

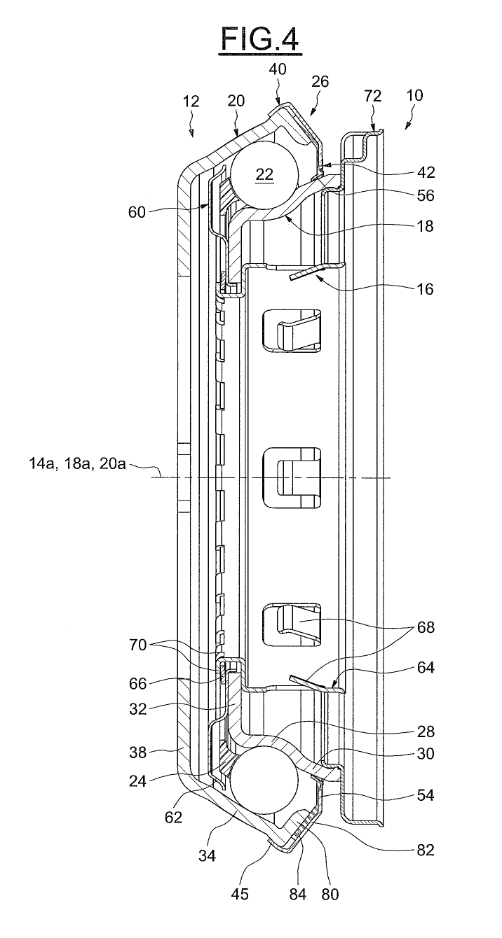

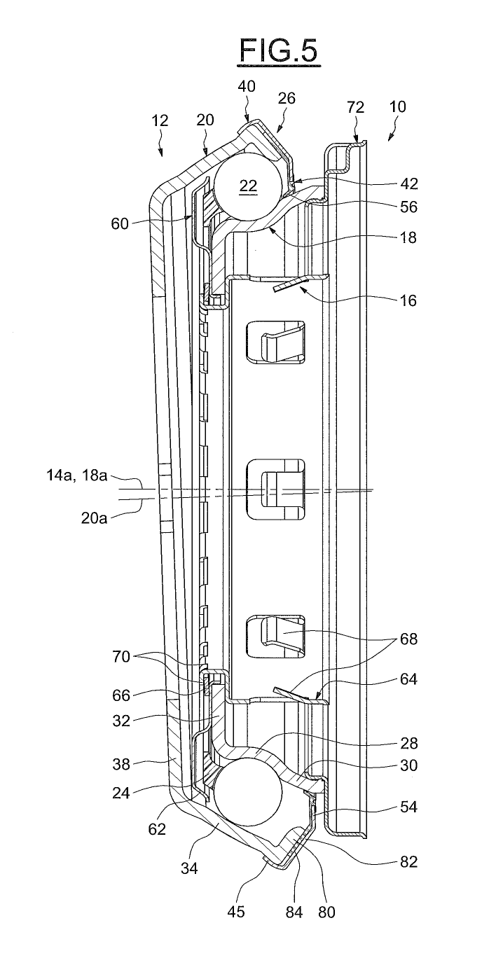

The embodiment illustrated in FIGS. 4 and 5, in which the identical elements bear the same references, differs mainly from the first embodiment described in that the outer ring 20 comprises an annular bearing portion 80 extending the large-diameter edge of the oblique portion 34 and extending obliquely inwards towards the oblique portion 30 of the inner ring 18. The bearing portion 80 forms a lap comprising an abutment surface situated facing the rolling elements 22 and offset axially towards the said elements relative to the lip 56 of the seal. The bearing portion 80 forms the abutment means coming into contact with the rolling elements 22 during the angular tilting of the outer ring 20 relative to the inner ring 18. Advantageously, the bearing portion 80 is sized so that, during the tilting of the outer ring, the contact between the said bearing portion and the rolling elements 22 is made in the angular range previously described for the first embodiment.

In this embodiment, the end-piece 40 of the seal comprises an oblique portion 82 connecting the end edge 45 and the radial portion 54 onto which the heel of the sealing packing 42 is overmoulded. The packing 42 also comprises a strip 84 extending from the said heel and partly covering the internal face of the end-piece 40 while being prestressed axially between the oblique portion 82 of the said end-piece and the bearing portion 80 of the outer ring. The strip 84 tends to resume its initial dimensions and to move the end-piece 40 in the direction opposite to the rolling elements 22, which causes an increased tightening of the end edge 45 on the outer ring.

In the embodiments described, the lip 56 of the seal is a friction lip. Alternatively, it could of course be possible to provide as a replacement or in combination a labyrinth lip.

1. A rolling bearing comprising:
an inner ring,
an outer ring, and
at least one row of rolling elements mounted between the said rings, one of the rings having at least one seal and being able to move angularly relative to the other ring so as to allow an angular tilting of the axis of the said ring relative to the axis of the other ring, and wherein
the said seal having at least one sealing lip made of a flexible material, and wherein
the rolling bearing includes at least one abutment means made of a rigid material and capable of interacting by contact with the rolling elements in order to limit the angular tilting of the moveable ring.

2. The bearing according to claim 1, wherein the abutment means is offset axially towards the rolling elements relative to the sealing lip.

3. The bearing according to claim 1, wherein the abutment means is made of a metal material.

4. The bearing according to claim 1, wherein the angle (a) formed in cross section between a radial mid-plane passing through the centre of the rolling elements and a plane passing through the said centre and the contact zone between the abutment means and the rolling elements is within the angular range from 5° to 50°.

5. The bearing according to claim 1, wherein the seal comprises an end-piece provided with at least one rib protruding towards the rolling elements and forming the abutment means.

6. The bearing according to claim 1, wherein the angularly moveable ring includes a bearing portion on which the seal is mounted and forming the abutment means.

7. The bearing according to claim 6, wherein the seal comprises an end-piece mounted one of directly and indirectly against the bearing portion of the moveable ring.

8. The bearing according to claim 1, wherein the angularly moveable ring is made in a single piece by stamping.

9. The bearing according to claim 1, wherein the angularly moveable ring is the outer ring.

10. A clutch release bearing device including a rolling bearing and a means for axially securing the rolling bearing to an operating element, the rolling bearing comprising:
an inner ring,
an outer ring,
at least one row of rolling elements mounted between the said rings, one of the rings having at least one seal and being able to move angularly relative to the other ring so as to allow an angular tilting of the axis of the said ring relative to the axis of the other ring, and wherein
the said seal having at least one sealing lip made of a flexible material, and wherein
the rolling bearing includes at least one abutment means made of a rigid material and capable of interacting by contact with the rolling elements in order to limit the angular tilting of the moveable ring.
